(19) United States
(12) Patent Application Publication
(10) Pub. No.: US 2015/0043446 A1
(43) Pub. Date: Feb. 12, 2015

(54) METHOD AND APPARATUS FOR COEXISTENCE OF DEVICE TO DEVICE AND LTE WAN COMMUNICATION USING SINGLE COMMUNICATION CHAIN

(71) Applicant: QUALCOMM Incorporated, San Diego, CA (US)

(72) Inventors: Georgios TSIRTSIS, London (GB); Shailesh PATIL, Bridgewater, NJ (US); Saurabha Rangrao TAVILDAR, Jersey City, NJ (US); Peter GAAL, San Diego, CA (US); Brian Clarke BANISTER, San Diego, CA (US)

(21) Appl. No.: 14/307,378

(22) Filed: Jun. 17, 2014

Related U.S. Application Data
(60) Provisional application No. 61/864,745, filed on Aug. 12, 2013.

(51) Int. Cl. H04W 72/10

(52) U.S. Cl. CPC H04W 72/10
USPC 370/329

(57) ABSTRACT

A method, an apparatus, and a computer program product for wireless communication are provided. The apparatus receives a priority for performing a wide area network (WAN) operation or a device-to-device (D2D) operation using a downlink receive chain, and performs the WAN operation or the D2D operation using the downlink receive chain according to the priority. In another aspect, the apparatus determines downlink resources on which a WAN operation is performed, refrains from scheduling the WAN operation on the downlink resources when the WAN operation is not scheduled or expected to be scheduled on the downlink resources, and sends to a device priority information indicating a priority for the device to perform the WAN operation or the D2D operation using a downlink receive chain when the WAN operation is scheduled or expected to be scheduled on the downlink resources.

### CROSS-REFERENCE TO RELATED APPLICATION(S)

This application claims the benefit of U.S. Provisional Application Ser. No. 61/864,745, entitled “METHOD AND APPARATUS FOR COEXISTENCE OF DEVICE TO DEVICE AND LTE WAN COMMUNICATION USING SINGLE COMMUNICATION CHAIN” and filed on Aug. 12, 2013, which is expressly incorporated by reference herein in its entirety.

### BACKGROUND

1. Field

The present disclosure relates generally to communication systems, and more particularly, to the coexistence of peer-to-peer communication and wide area network (WAN) communication in the presence of a single radio frequency (RF) chain.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. The apparatus receives priority information indicating a priority for performing at least one of a wide area network (WAN) operation or a device-to-device (D2D) operation using a downlink receive chain, and performs the WAN operation or the D2D operation using the downlink receive chain according to the priority.

In another aspect of the disclosure, the apparatus determines downlink resources on which a WAN operation is performed, refrains from scheduling the WAN operation on the downlink resources when the WAN operation is not scheduled or expected to be scheduled on the downlink resources, and sends to a device priority information indicating a priority for the device to perform at least one of the WAN operation or the D2D operation using a downlink receive chain when the WAN operation is scheduled or expected to be scheduled on the downlink resources.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram of a device-to-device communications system.

FIG. 8 is a flow chart of a method of wireless communication.

FIG. 9 is a flow chart of a method of wireless communication.

FIG. 10 is a conceptual data flow diagram illustrating the data flow between different modules/means/components in an exemplary apparatus.

FIG. 11 is a conceptual data flow diagram illustrating the data flow between different modules/means/components in an exemplary apparatus.

FIG. 12 is a diagram illustrating an example of a hardware implementation for an apparatus employing a processing system.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

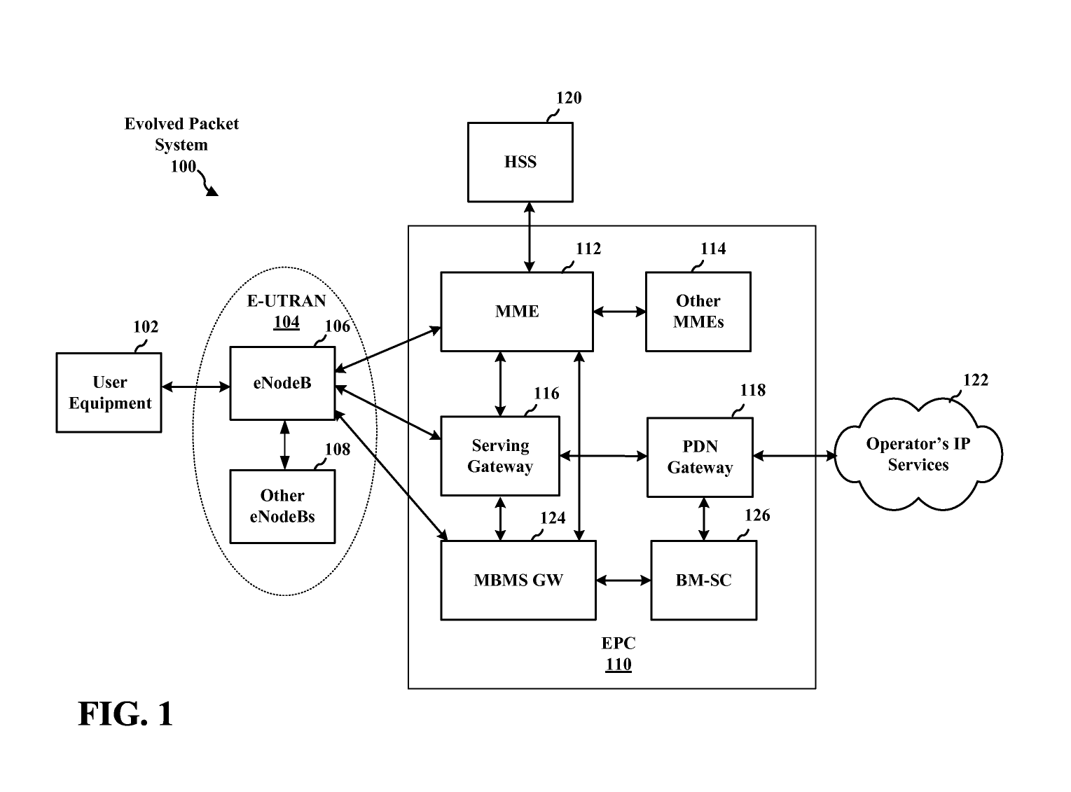

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

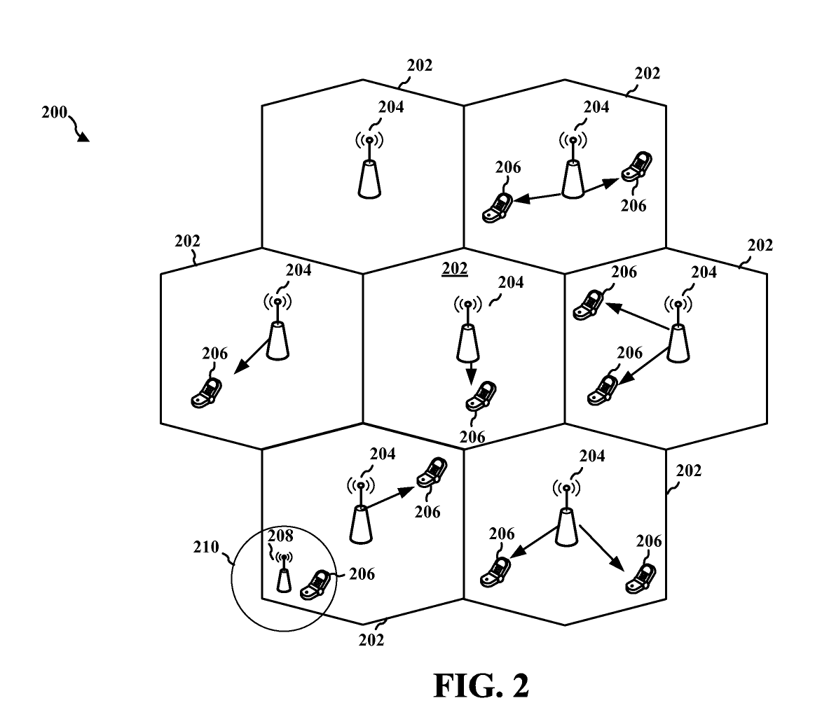

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sector). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

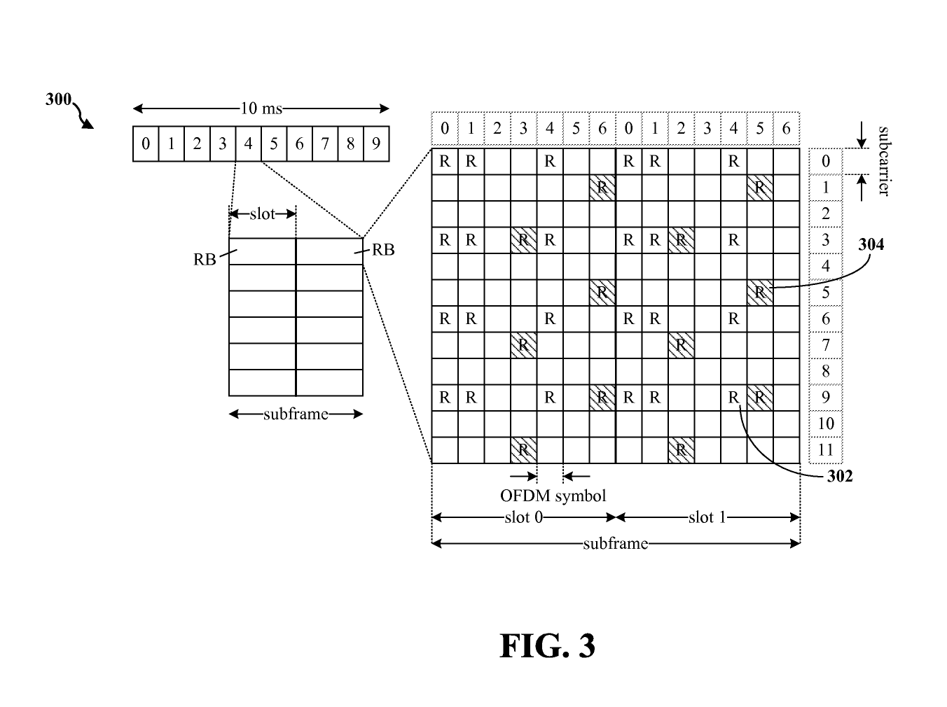

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

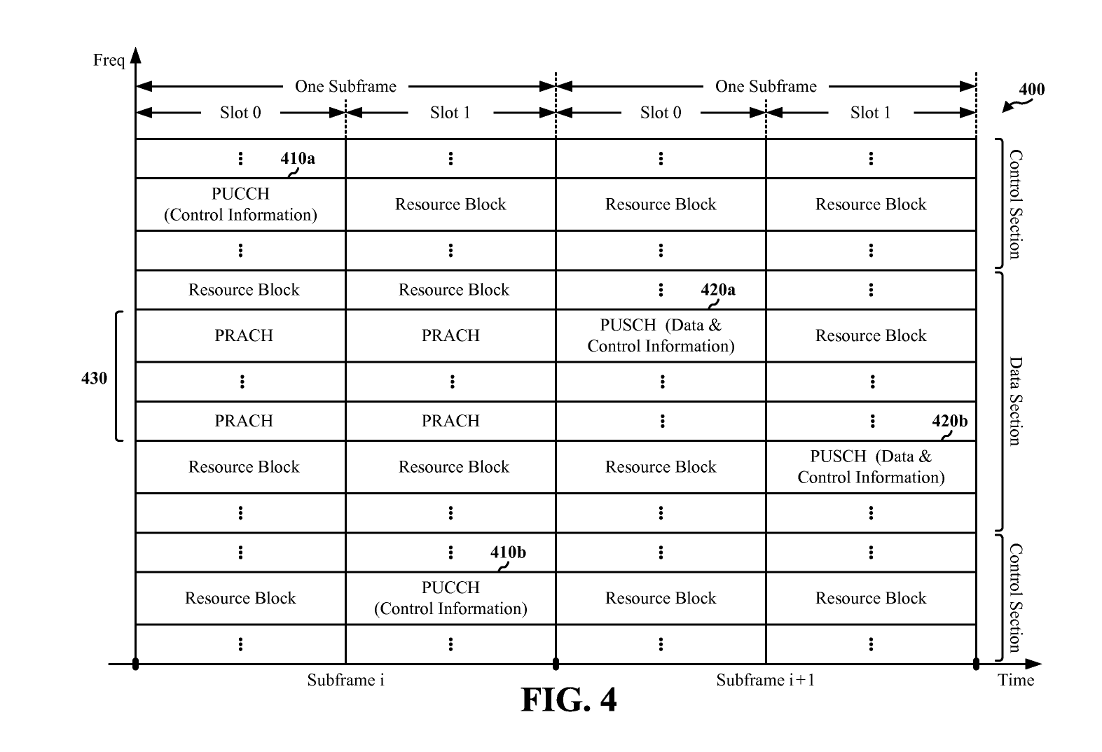

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

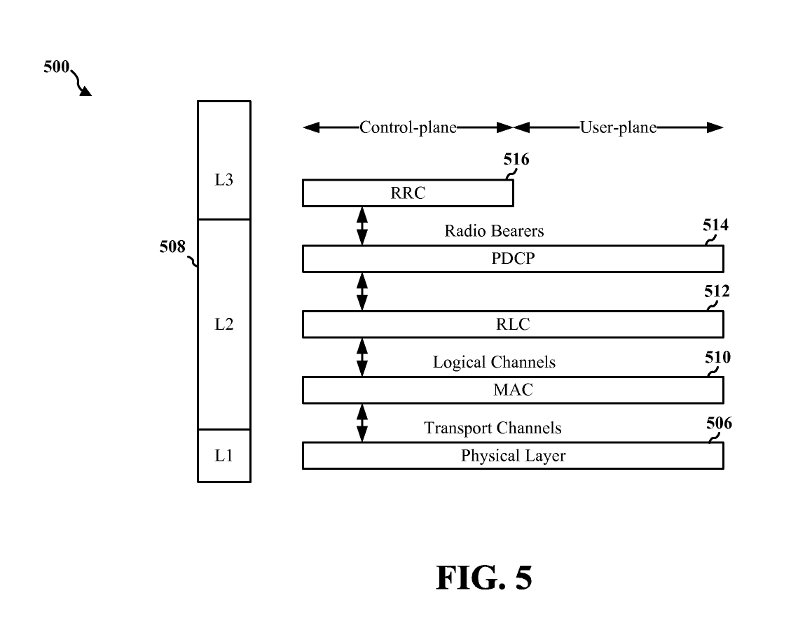

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

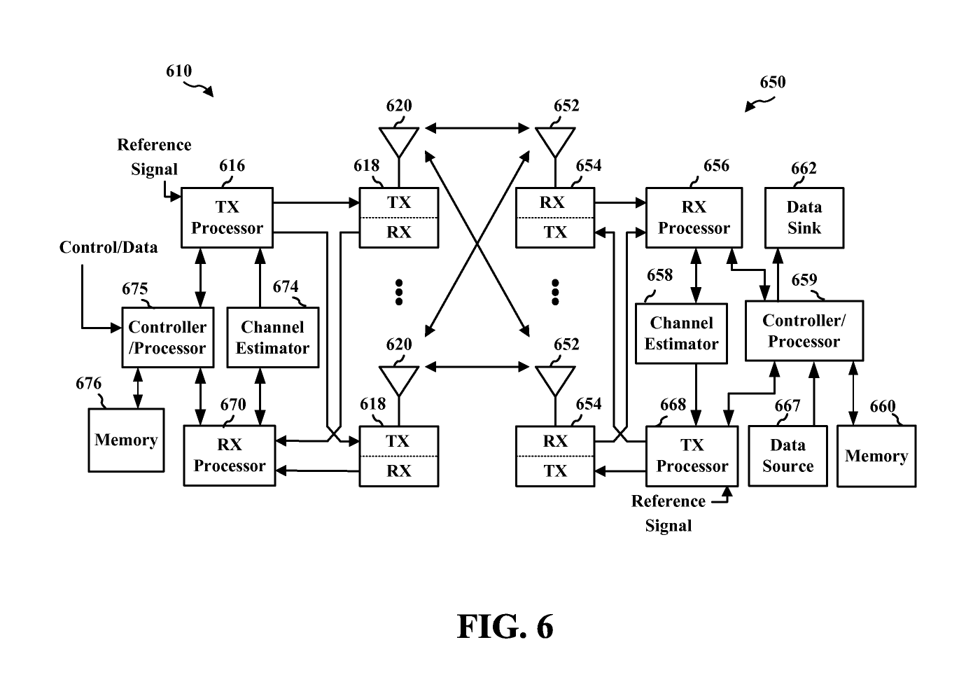

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

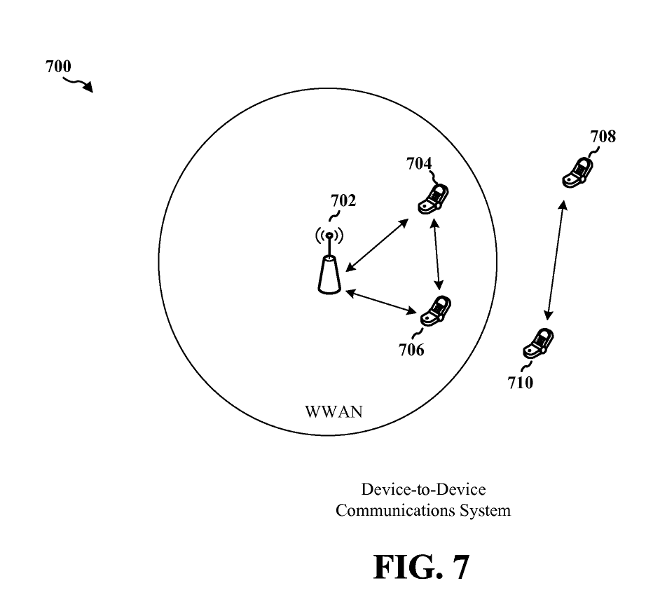

FIG. 7 is a diagram of a device-to-device communications system 700. The device-to-device communications system 700 includes a plurality of wireless devices 704, 706, 708, 710. The device-to-device communications system 700 may overlap with a cellular communications system, such as for example, a wireless wide area network (WWAN). Some of the wireless devices 704, 706, 708, 710 may communicate together in device-to-device communication using the DL/UL WWAN spectrum, some may communicate with the base station 702, and some may do both. For example, as shown in FIG. 7, the wireless devices 708, 710 are in device-to-device communication and the wireless devices 704, 706 are in device-to-device communication. The wireless devices 704, 706 are also communicating with the base station 702.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

Generally, when performing device-to-device (D2D) communication, a device transmits and receives on the same frequency spectrum. Due to cost and regulatory issues in a wide area network (WAN) deployment, an uplink spectrum may be the preferred spectrum for performing the D2D communication. Implementing D2D communication on the uplink spectrum involves implementing a communication chain to receive on the uplink spectrum. However, adding an additional communication chain may be expensive and therefore not preferred for D2D/WAN implementations. In an aspect, a cost effective way of implementing the communication chain may be to reuse a chain used for downlink spectrum reception. That is, the communication chain used to receive on the downlink spectrum may be tuned to receive on the uplink spectrum. For example, when performing the D2D communication using a downlink communication chain (also referred to as downlink RF chain, downlink receive chain, etc.), the downlink communication chain may be tuned to receive on uplink resources (uplink spectrum). The D2D communication may then be performed on the uplink resources using the tuned downlink communication chain. The downlink communication chain may include two parts: a radio frequency (RF) part and a baseband part. The RF part may be tuned to receive on the uplink resources for performing the D2D communication.

Reusing the downlink communication chain for D2D communication may lead to coexistence issues. For example, suppose a UE has data scheduled to be received on the downlink spectrum during a same time that the UE will participate in D2D communication. Accordingly, the UE is faced with the issue of whether to utilize the downlink spectrum to receive the scheduled data or participate in the D2D communication. The present disclosure provides solutions for resolving such issues.

In an aspect, a scheduler (e.g., base station or eNB) refrains from scheduling a WAN operation (e.g. WAN paging, PDCCH, etc.) on downlink resources for one or more UEs expected to perform a D2D operation (e.g., D2D discovery/communication) using a downlink receive chain. If the scheduler is unable to schedule in such a manner, the scheduler may indicate to the one or more UEs whether to prioritize the WAN operation over the D2D operation, or vice versa. For example, the scheduler may send a signal to the UE indicating whether to treat WAN paging or D2D discovery/communication with a higher priority. In another example, the scheduler may send a signal to the UE indicating whether to treat reception of a physical downlink control channel (PDCCH) or D2D discovery/communication with a higher priority. In a further example, a UE may be scheduled to perform a WAN operation according to a semi-persistent schedule (SPS). Accordingly, the SPS-scheduled UE may also receive an indication from the scheduler of a priority between the WAN operation and the D2D operation.

If the D2D operation is prioritized over the WAN operation, the scheduler may signal additional information to the UE in order to recover performance loss from the WAN operation. For example, the scheduler may signal additional information indicating downlink resources on which the UE may perform the WAN operation. Additionally or alternatively, the additional information may indicate a specific downlink receive chain of a plurality of receive chains (e.g., for carrier aggregation) to use for the D2D operation and/or a D2D resource band on which the downlink receive chain is to be used for the D2D operation.

In an aspect, whether a WAN operation is prioritized over a D2D operation may depend on the type of D2D operation involved. For example, the WAN operation may be prioritized over the D2D operation when the D2D operation involves D2D discovery. In another example, the D2D operation may be prioritized over the WAN operation when the D2D operation involves D2D communication.

An exemplary implementation of the present disclosure is described as follows. An RRC_IDLE UE may engage in D2D discovery using a downlink receive chain. During a subframe on which discovery occurs, the UE may be paged by a network on the downlink spectrum. The network may try to ensure that no conflict occurs, e.g., no D2D discovery is performed during subframes having paging occasions. However, if the network is unable to ensure that no conflict occurs, the network may indicate to the UE whether to use the downlink receive chain to receive the downlink paging message or participate in the D2D discovery during the conflict. If the UE is instructed to prioritize the D2D discovery, the network may send additional information to the UE indicating other subframe(s) for receiving the paging message. For example, the network may indicate an offset value to the UE. The UE may then expect to receive the paging message in a subframe occurring before or after the conflicted subframe according to the offset value. Additionally or alternatively, the additional information may indicate a specific downlink receive chain of a plurality of receive chains to use for the D2D discovery. The additional information may also indicate a specific D2D resource band on which the downlink receive chain is to be used for the D2D discovery.

Another exemplary implementation of the present disclosure is described as follows. An RRC_CONNECTED UE may have delay-sensitive downlink traffic. Accordingly, a conflict may occur due to delay-sensitive downlink traffic flows semi-persistently scheduled on subframes where D2D operations occur. If a semi-persistently scheduled occasion (downlink communication) collides with a D2D discovery subframe, then the network may instruct the UE to prioritize reception of the downlink communication on the downlink receive chain. Notably, D2D discovery transmissions may be periodic; therefore, the UE can receive the D2D discovery transmissions during a next period. However, if the semi-persistently scheduled occasion collides with a public safety-related D2D broadcast subframe (D2D communication), the network may instruct the UE to prioritize performance of the D2D communication on the downlink receive chain.

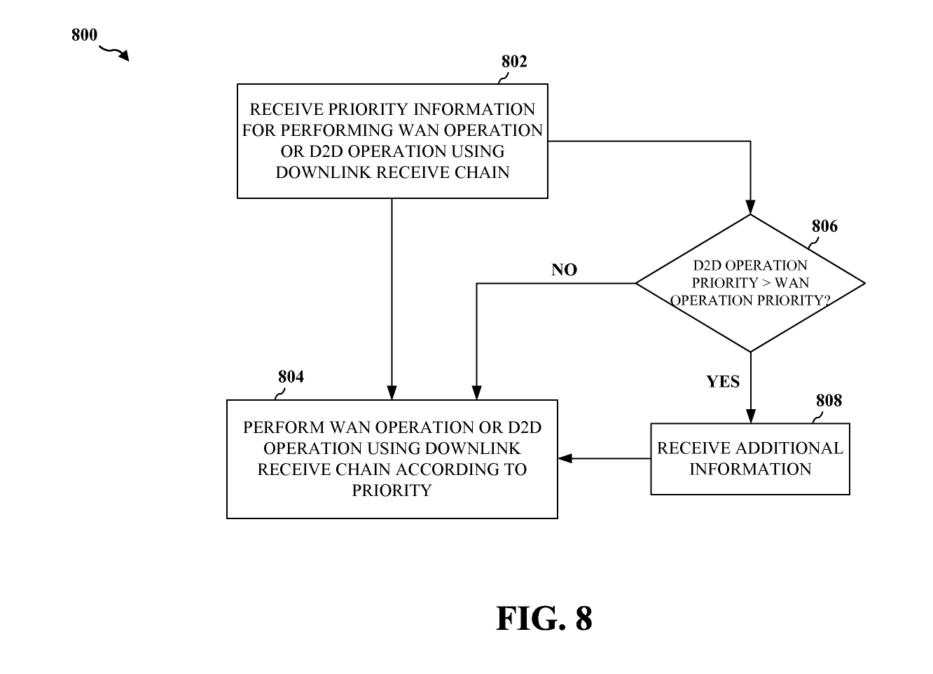

FIG. 8 is a flow chart 800 of a method of wireless communication. The method may be performed by a UE. At step 802, the UE receives priority information indicating a priority for performing at least one of a wide area network (WAN) operation or a device-to-device (D2D) operation using a downlink receive chain. The D2D operation may include the UE performing D2D discovery or a D2D communication with a peer device using the downlink receive chain tuned to receive on uplink resources (e.g., uplink spectrum). The WAN operation may include the UE receiving WAN paging or receiving a physical downlink control channel (PDCCH) using the downlink receive chain.

At step 804, the UE performs the WAN operation or the D2D operation using the downlink receive chain according to the priority. The D2D operation may be performed when the priority information indicates that the D2D operation has a greater priority than the WAN operation. When performing the D2D operation, the downlink receive chain is first tuned to receive on uplink resources. The D2D operation is then performed on the uplink resources using the tuned downlink receive chain. In an aspect, the downlink receive chain may include two parts: a radio frequency (RF) part and a baseband part. Accordingly, the RF part may be tuned to receive on the uplink resources for performing the D2D operation. The WAN operation may be performed when the priority information indicates that the WAN operation has a greater priority than the D2D operation.

In an aspect, at step 806, after the UE receives the priority information (step 802), the UE determines whether the D2D operation has the greater priority than the WAN operation. When the WAN operation has the greater priority, the UE may proceed to step 804 and perform the WAN operation using the downlink receive chain. However, when the D2D operation has the greater priority, the UE may proceed to step 808.

At step 808, the UE receives additional information when the priority information indicates that the D2D operation has the greater priority than the WAN operation. The additional information may indicate downlink resources for performing the WAN operation. For example, the additional information may indicate an offset value to the UE. The UE may then locate, based on the offset value, downlink resources for performing the WAN operation that occur before or after resources used for performing the prioritized D2D operation. Additionally or alternatively, the additional information may indicate a specific downlink receive chain of a plurality of receive chains to use for the D2D operation and/or a D2D resource band on which the downlink receive chain is to be used for the D2D operation. Thereafter, the UE may proceed to step 804 and perform the prioritized D2D operation using the tuned downlink receive chain.

In an aspect, the WAN operation is scheduled to be performed according to a semi-persistent schedule (SPS). Accordingly, the WAN operation may have the greater priority than the D2D operation when the D2D operation involves the UE performing the D2D discovery. Alternatively, the D2D operation may have the greater priority than the WAN operation when the D2D operation involves the UE performing the D2D communication with the peer device related to public safety.

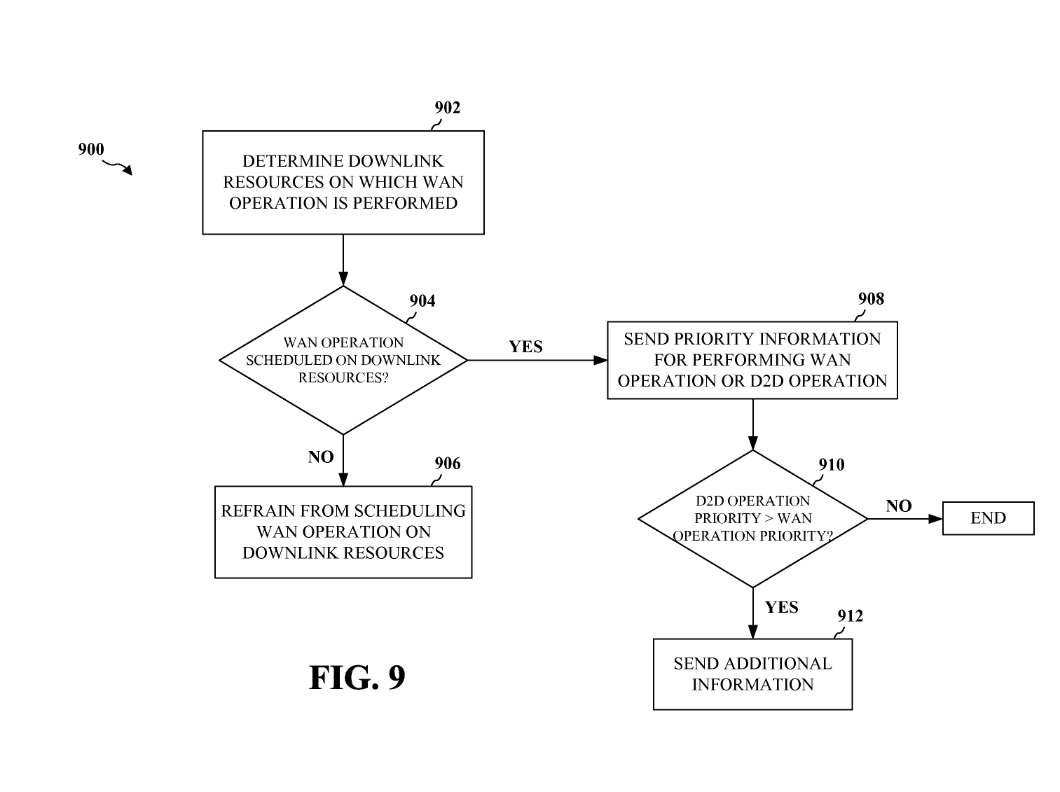

FIG. 9 is a flow chart 900 of a method of wireless communication. The method may be performed by a scheduler (e.g., base station or eNB). At step 902, the scheduler determines downlink resources on which a WAN operation is performed.

At step 904, the scheduler determines whether the WAN operation is scheduled or expected to be scheduled on the downlink resources. The WAN operation includes a device receiving WAN paging or receiving a physical downlink control channel (PDCCH) using a downlink receive chain. At step 906, the scheduler refrains from scheduling the WAN operation on the downlink resources when the WAN operation is not scheduled or expected to be scheduled on the downlink resources.

At step 908, when the WAN operation is scheduled or expected to be scheduled on the downlink resources, the scheduler may send to the device priority information. The priority information indicates a priority for the device to perform at least one of the WAN operation or the D2D operation using the downlink receive chain. The device is indicated to tune the downlink receive chain to receive on uplink resources and perform the D2D operation on the uplink resources using the tuned downlink receive chain when the priority information indicates that the D2D operation has a greater priority than the WAN operation. The D2D operation may include the device performing D2D discovery or a D2D communication between the device and a peer device using the tuned downlink receive chain. Alternatively, the device is indicated to perform the WAN operation using the downlink receive chain when the priority information indicates that the WAN operation has a greater priority than the D2D operation.

At step 910, the scheduler may determine whether the D2D operation has the greater priority than the WAN operation. At step 912, when the D2D operation has the greater priority, the scheduler may send to the device additional information. The additional information may indicate downlink resources for the device to perform the WAN operation. For example, the additional information may indicate an offset value to the device. The device may then locate, based on the offset value, downlink resources for performing the WAN operation that occur before or after resources used for performing the prioritized D2D operation. Additionally or alternatively, the additional information may indicate a specific downlink receive chain of a plurality of receive chains for the device to use for the D2D operation and/or a D2D resource band on which the downlink receive chain is to be used by the device for the D2D operation.

In an aspect, the WAN operation is scheduled to be performed according to a semi-persistent schedule (SPS). Accordingly, the WAN operation may have the greater priority than the D2D operation when the D2D operation involves the device performing the D2D discovery. Alternatively, the D2D operation may have the greater priority than the WAN operation when the D2D operation involves the D2D communication between the device and the peer device related to public safety.

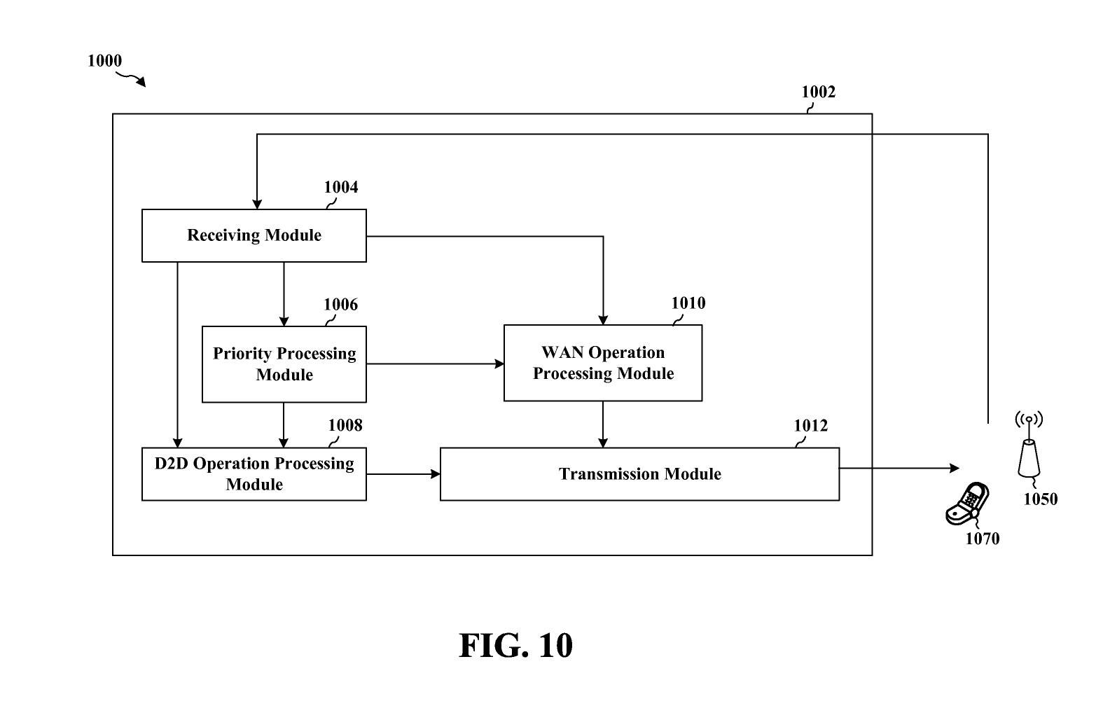

FIG. 10 is a conceptual data flow diagram 1000 illustrating the data flow between different modules/means/components in an exemplary apparatus 1002. The apparatus may be a UE. The apparatus includes a receiving module 1004, a priority processing module 1006, a D2D operation processing module 1008, a WAN operation processing module 1010, and a transmission module 1012.

The priority processing module 1006 receives (via the receiving module 1004) priority information indicating a priority for performing at least one of a wide area network (WAN) operation or a device-to-device (D2D) operation using a downlink receive chain. For example, the priority information may be received from a base station 1050. The D2D operation may include the D2D operation processing module 1008 performing D2D discovery or a D2D communication with a peer device 1070 using the downlink receive chain tuned to receive on uplink resources (e.g., uplink spectrum). The WAN operation may include the WAN operation processing module 1010 receiving WAN paging or receiving a physical downlink control channel (PDCCH) using the downlink receive chain.

The WAN operation processing module 1010 performs the WAN operation or the D2D operation processing module 1008 performs the D2D operation using the downlink receive chain according to the priority. The D2D operation may be performed when the priority information indicates that the D2D operation has a greater priority than the WAN operation. When performing the D2D operation, the downlink receive chain is first tuned to receive on uplink resources. The D2D operation is then performed on the uplink resources using the tuned downlink receive chain. In an aspect, the downlink receive chain may include two parts: a radio frequency (RF) part and a baseband part. Accordingly, the RF part may be tuned to receive on the uplink resources for performing the D2D operation. The WAN operation may be performed when the priority information indicates that the WAN operation has a greater priority than the D2D operation.

In an aspect, after the priority processing module 1006 receives the priority information, the priority processing module 1006 determines whether the D2D operation has the greater priority than the WAN operation. When the WAN operation has the greater priority, the WAN operation processing module 1010 may proceed to perform the WAN operation using the downlink receive chain. However, when the D2D operation has the greater priority, the priority processing module 1006 may receive additional information.

The additional information may indicate downlink resources for performing the WAN operation. For example, the additional information may indicate an offset value to the WAN operation processing module 1010. The WAN operation processing module 1010 may then locate, based on the offset value, downlink resources for performing the WAN operation that occur before or after resources used for performing the prioritized D2D operation. Additionally or alternatively, the additional information may indicate a specific downlink receive chain of a plurality of receive chains for the D2D operation processing module 1008 to use for the D2D operation and/or a D2D resource band on which the downlink receive chain is to be used by the D2D operation processing module 1008 for the D2D operation. Thereafter, the D2D operation processing module 1008 may proceed to perform the prioritized D2D operation using the downlink receive chain.

In an aspect, the WAN operation is scheduled to be performed according to a semi-persistent schedule (SPS). Accordingly, the WAN operation may have the greater priority than the D2D operation when the D2D operation involves the D2D operation processing module 1008 performing the D2D discovery. Alternatively, the D2D operation may have the greater priority than the WAN operation when the D2D operation involves the D2D operation processing module 1008 performing the D2D communication with the peer device 1070 related to public safety.

The apparatus may include additional modules that perform each of the steps of the algorithm in the aforementioned flow chart of FIG. 8. As such, each step in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

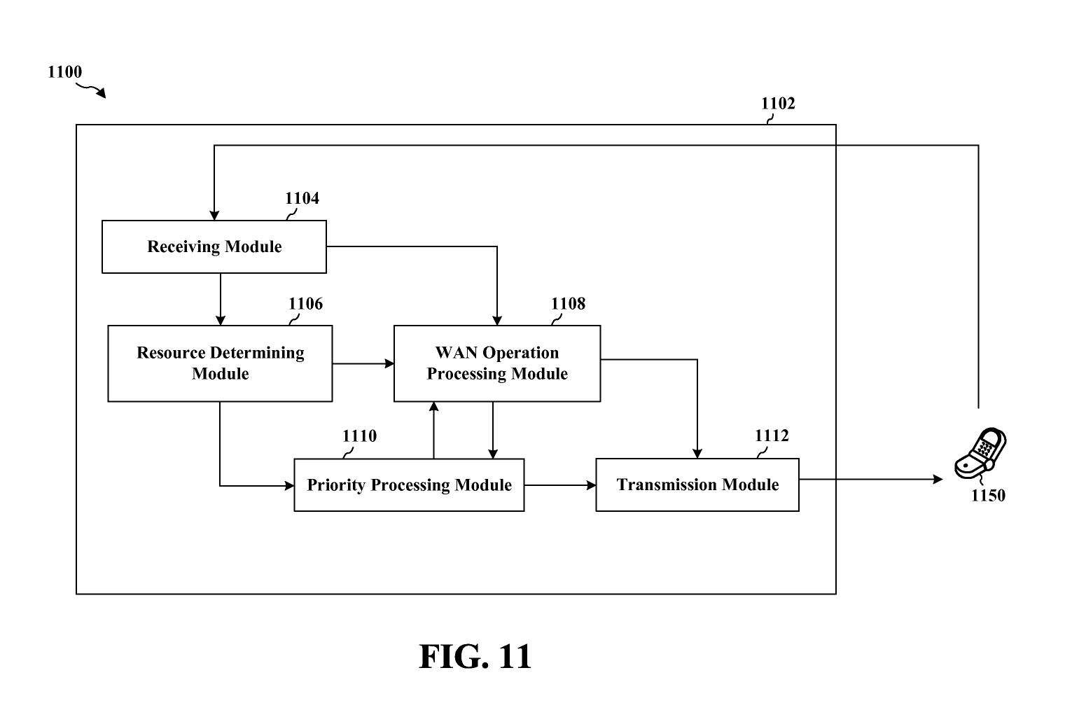

FIG. 11 is a conceptual data flow diagram 1200 illustrating the data flow between different modules/means/components in an exemplary apparatus 1102. The apparatus may be a scheduler (e.g., base station or eNB). The apparatus includes a receiving module 1104, a resource determining module 1106, a WAN operation processing module 1108, a priority processing module 1110, and a transmission module 1112.

The resource determining module 1106 determines downlink resources on which a WAN operation is performed.

The WAN operation processing module 1108 determines whether the WAN operation is scheduled or expected to be scheduled on the downlink resources. The WAN operation includes a device 1150 receiving WAN paging or receiving a physical downlink control channel (PDCCH) using a downlink receive chain. The WAN operation processing module 1108 refrains from scheduling the WAN operation on the downlink resources when the WAN operation is not scheduled or expected to be scheduled on the downlink resources.

When the WAN operation is scheduled or expected to be scheduled on the downlink resources, the priority processing module 1110 may send to the device 1150 priority information via the transmission module 1112. The priority information indicates a priority for the device 1150 to perform at least one of the WAN operation or the D2D operation using the downlink receive chain. The device 1150 is indicated to tune the downlink receive chain to receive on uplink resources and perform the D2D operation on the uplink resources using the tuned downlink receive chain when the priority information indicates that the D2D operation has a greater priority than the WAN operation. The D2D operation may include the device 1150 performing D2D discovery or a D2D communication between the device 1150 and a peer device using the tuned downlink receive chain. Alternatively, the device 1150 is indicated to perform the WAN operation when the priority information indicates that the WAN operation has a greater priority than the D2D operation.

The priority processing module 1110 may determine whether the D2D operation has the greater priority than the WAN operation. When the D2D operation has the greater priority, the WAN operation processing module 1108 may send to the device 1150 additional information via the transmission module 1112. The additional information may indicate downlink resources for the device 1150 to perform the WAN operation. For example, the additional information may indicate an offset value to the device 1150. The device 1150 may then locate, based on the offset value, downlink resources for performing the WAN operation that occur before or after resources used for performing the prioritized D2D operation. Additionally or alternatively, the additional information may indicate a specific downlink receive chain of a plurality of receive chains for the device 1150 to use for the D2D operation and/or a D2D resource band on which the downlink receive chain is to be used by the device 1150 for the D2D operation.

In an aspect, the WAN operation is scheduled to be performed according to a semi-persistent schedule (SPS). Accordingly, the WAN operation may have the greater priority than the D2D operation when the D2D operation involves the device 1150 performing the D2D discovery. Alternatively, the D2D operation may have the greater priority than the WAN operation when the D2D operation involves the D2D communication between the device 1150 and the peer device related to public safety.

The apparatus may include additional modules that perform each of the steps of the algorithm in the aforementioned flow chart of FIG. 9. As such, each step in the aforementioned flow charts of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

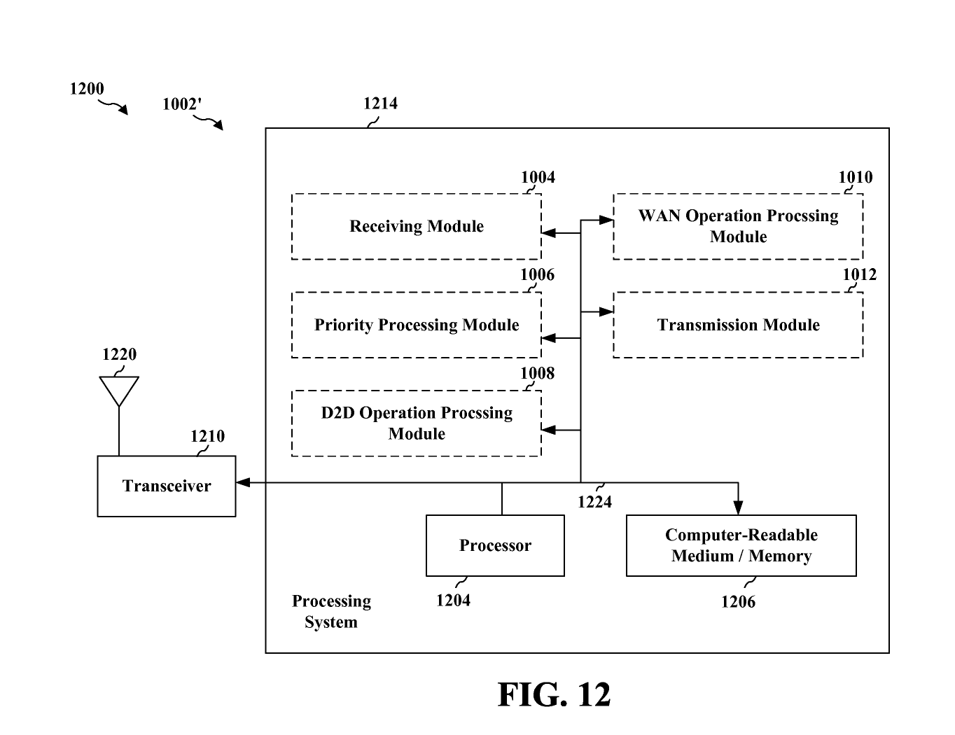

FIG. 12 is a diagram 1200 illustrating an example of a hardware implementation for an apparatus 1002′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1004, 1006, 1008, 1010, 1012, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the receiving module 1004. In addition, the transceiver 1210 receives information from the processing system 1214, specifically the transmission module 1012, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system further includes at least one of the modules 1004, 1006, 1008, 1010, and 1012. The modules may be software modules running in the processor 1204, resident/stored in the computer readable medium/memory 1206, one or more hardware modules coupled to the processor 1204, or some combination thereof. The processing system 1214 may be a component of the UE 650 and may include the memory 660 and/or at least one of the TX processor 668, the RX processor 656, and the controller/processor 659.

In one configuration, the apparatus 1002/1002′ for wireless communication includes means for receiving priority information indicating a priority for performing at least one of a wide area network (WAN) operation or a device-to-device (D2D) operation using a downlink receive chain, means for performing the WAN operation or the D2D operation using the downlink receive chain according to the priority, and means for receiving additional information when the priority information indicates that the D2D operation has the greater priority than the WAN operation, the additional information indicating downlink resources for performing the WAN operation.

The aforementioned means may be one or more of the aforementioned modules of the apparatus 1002 and/or the processing system 1214 of the apparatus 1002′ configured to perform the functions recited by the aforementioned means. As described supra, the processing system 1214 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

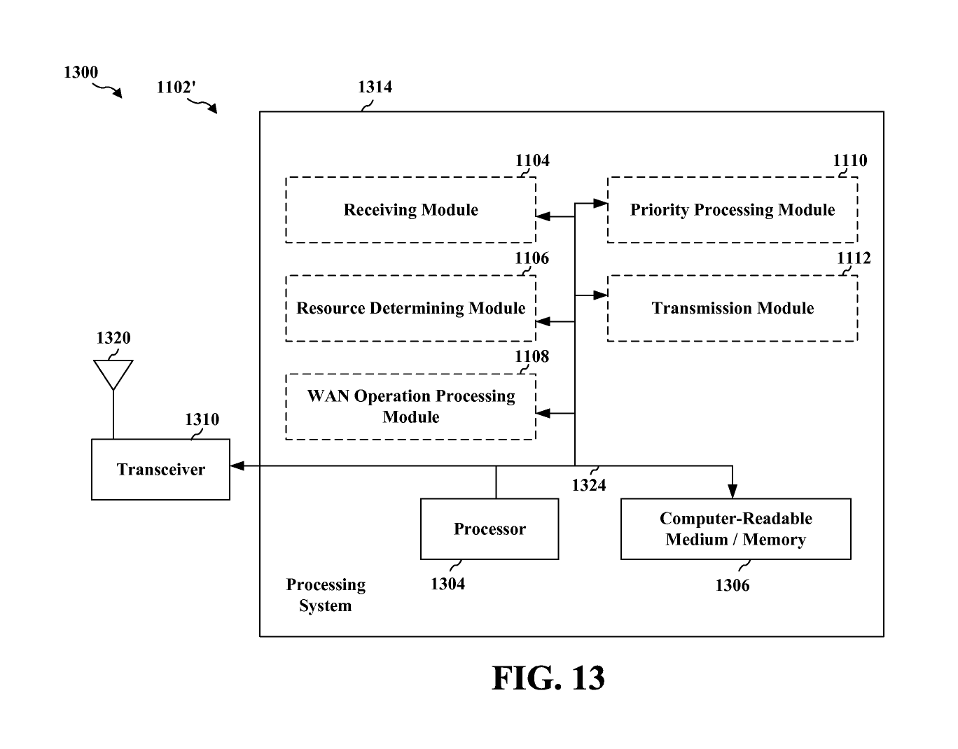

FIG. 13 is a diagram 1300 illustrating an example of a hardware implementation for an apparatus 1102′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1104, 1106, 1108, 1110, 1112, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314, specifically the receiving module 1104. In addition, the transceiver 1310 receives information from the processing system 1314, specifically the transmission module 1112, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system further includes at least one of the modules 1104, 1106, 1108, 1110, and 1112. The modules may be software modules running in the processor 1304, resident/stored in the computer readable medium/memory 1306, one or more hardware modules coupled to the processor 1304, or some combination thereof. The processing system 1314 may be a component of the eNB 610 and may include the memory 676 and/or at least one of the TX processor 616, the RX processor 670, and the controller/processor 675.

In one configuration, the apparatus 1102/1102′ for wireless communication includes means for determining downlink resources on which a WAN operation is scheduled or expected to be scheduled, means for refraining from scheduling the WAN operation on the downlink resources when the WAN operation is not scheduled or expected to be scheduled on the downlink resources, means for sending to a device priority information indicating a priority for the device to perform at least one of the WAN operation or the D2D operation using a downlink receive chain when the WAN operation is scheduled or expected to be scheduled on the downlink resources, and means for sending to the device additional information when the priority information indicates that the D2D operation has the greater priority than the WAN operation, the additional information indicating downlink resources for the device to perform the WAN operation.

The aforementioned means may be one or more of the aforementioned modules of the apparatus 1102 and/or the processing system 1314 of the apparatus 1102′ configured to perform the functions recited by the aforementioned means. As described supra, the processing system 1314 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving priority information indicating a priority for performing at least one of a wide area network (WAN) operation or a device-to-device (D2D) operation using a downlink receive chain; and
performing the WAN operation or the D2D operation using the downlink receive chain according to the priority.

2. The method of claim 1,
wherein the D2D operation is performed when the priority information indicates that the D2D operation has a greater priority than the WAN operation, the performing the D2D operation comprising tuning the downlink receive chain to receive on uplink resources and performing the D2D operation on the uplink resources using the tuned downlink receive chain; and
wherein the WAN operation is performed when the priority information indicates that the WAN operation has a greater priority than the D2D operation.

3. The method of claim 2, further comprising:
receiving additional information when the priority information indicates that the D2D operation has the greater priority than the WAN operation.

4. The method of claim 3, wherein the additional information indicates at least one of:
downlink resources for performing the WAN operation;
a specific downlink receive chain of a plurality of receive chains to use for the D2D operation; or
a D2D resource band on which the downlink receive chain is to be used for the D2D operation.

5. The method of claim 2, wherein:
the D2D operation comprises D2D discovery or a D2D communication with a peer device using the tuned downlink receive chain; and
the WAN operation comprises receiving WAN paging or receiving a physical downlink control channel (PDCCH) using the downlink receive chain.

6. The method of claim 5, wherein the WAN operation is scheduled to be performed according to a semi-persistent schedule (SPS),
wherein the WAN operation has the greater priority than the D2D operation when the D2D operation comprises the D2D discovery, and
wherein the D2D operation has the greater priority than the WAN operation when the D2D operation comprises a D2D communication with the peer device related to public safety.

7. A method of wireless communication performed by a scheduler, comprising:
determining downlink resources on which a wide area network (WAN) operation is performed;
refraining from scheduling the WAN operation on the downlink resources when the WAN operation is not scheduled or expected to be scheduled on the downlink resources; and
sending to a device priority information indicating a priority for the device to perform at least one of the WAN operation or a device-to-device (D2D) operation using a downlink receive chain when the WAN operation is scheduled or expected to be scheduled on the downlink resources.

8. The method of claim 7, wherein:
the device is indicated to tune the downlink receive chain to receive on uplink resources and perform the D2D operation on the uplink resources using the tuned downlink receive chain when the priority information indicates that the D2D operation has a greater priority than the WAN operation; and
the device is indicated to perform the WAN operation using the downlink receive chain when the priority information indicates that the WAN operation has a greater priority than the D2D operation.

9. The method of claim 8, further comprising:
sending to the device additional information when the priority information indicates that the D2D operation has the greater priority than the WAN operation.

10. The method of claim 9, wherein the additional information indicates at least one of:
downlink resources for the device to perform the WAN operation;
a specific downlink receive chain of a plurality of receive chains for the device to use for the D2D operation; or
a D2D resource band on which the downlink receive chain is to be used by the device for the D2D operation.

11. The method of claim 8, wherein:
the D2D operation comprises D2D discovery or a D2D communication between the device and a peer device using the tuned downlink receive chain; and
the WAN operation comprises the device receiving WAN paging or receiving a physical downlink control channel (PDCCH) using the downlink receive chain.

12. The method of claim 11, wherein the WAN operation is scheduled to be performed according to a semi-persistent schedule (SPS),
wherein the WAN operation has the greater priority than the D2D operation when the D2D operation comprises the D2D discovery, and
wherein the D2D operation has the greater priority than the WAN operation when the D2D operation comprises a D2D communication between the device and the peer device related to public safety.

13. An apparatus for wireless communication, comprising:
means for receiving priority information indicating a priority for performing at least one of a wide area network (WAN) operation or a device-to-device (D2D) operation using a downlink receive chain; and
means for performing the WAN operation or the D2D operation using the downlink receive chain according to the priority.

14. The apparatus of claim 13,
wherein the D2D operation is performed when the priority information indicates that the D2D operation has a greater priority than the WAN operation, the means for performing the D2D operation configured to tune the downlink receive chain to receive on uplink resources and perform the D2D operation on the uplink resources using the tuned downlink receive chain; and
wherein the WAN operation is performed when the priority information indicates that the WAN operation has a greater priority than the D2D operation.

15. The apparatus of claim 14, further comprising:
means for receiving additional information when the priority information indicates that the D2D operation has the greater priority than the WAN operation.

16. The apparatus of claim 15, wherein the additional information indicates at least one of:
downlink resources for performing the WAN operation;
a specific downlink receive chain of a plurality of receive chains to use for the D2D operation; or
a D2D resource band on which the downlink receive chain is to be used for the D2D operation.

17. The apparatus of claim 14, wherein:
the D2D operation comprises D2D discovery or a D2D communication with a peer device using the tuned downlink receive chain; and
the WAN operation comprises receiving WAN paging or receiving a physical downlink control channel (PDCCH) using the downlink receive chain.

18. The apparatus of claim 17, wherein the WAN operation is scheduled to be performed according to a semi-persistent schedule (SPS),
wherein the WAN operation has the greater priority than the D2D operation when the D2D operation comprises the D2D discovery, and
wherein the D2D operation has the greater priority than the WAN operation when the D2D operation comprises a D2D communication with the peer device related to public safety.

19. An apparatus for wireless communication, comprising:
means for determining downlink resources on which a wide area network (WAN) operation is performed;
means for refraining from scheduling the WAN operation on the downlink resources when the WAN operation is not scheduled or expected to be scheduled on the downlink resources; and
means for sending to a device priority information indicating a priority for the device to perform at least one of the WAN operation or a device-to-device (D2D) operation using a downlink receive chain when the WAN operation is scheduled or expected to be scheduled on the downlink resources.

20. The apparatus of claim 19, wherein:
the device is indicated to tune the downlink receive chain to receive on uplink resources and perform the D2D operation on the uplink resources using the tuned downlink receive chain when the priority information indicates that the D2D operation has a greater priority than the WAN operation; and
the device is indicated to perform the WAN operation using the downlink receive chain when the priority information indicates that the WAN operation has a greater priority than the D2D operation.

21. The apparatus of claim 20, further comprising:
means for sending to the device additional information when the priority information indicates that the D2D operation has the greater priority than the WAN operation.

22. The apparatus of claim 21, wherein the additional information indicates at least one of:
downlink resources for the device to perform the WAN operation;
a specific downlink receive chain of a plurality of receive chains for the device to use for the D2D operation; or
a D2D resource band on which the downlink receive chain is to be used by the device for the D2D operation.

23. The apparatus of claim 20, wherein:
the D2D operation comprises D2D discovery or a D2D communication between the device and a peer device using the tuned downlink receive chain; and
the WAN operation comprises the device receiving WAN paging or receiving a physical downlink control channel (PDCCH) using the downlink receive chain.

24. The apparatus of claim 23, wherein the WAN operation is scheduled to be performed according to a semi-persistent schedule (SPS),
wherein the WAN operation has the greater priority than the D2D operation when the D2D operation comprises the D2D discovery, and
wherein the D2D operation has the greater priority than the WAN operation when the D2D operation comprises a D2D communication between the device and the peer device related to public safety.
